(19) United States
(12) Patent Application Publication
(10) Pub. No.: US 2010/0146415 A1
(43) Pub. Date: Jun. 10, 2010

(54) DNS PREFETCH

(75) Inventor: Peter Lepeska, Boston, MA (US)

Correspondence Address: TOWNSEND AND TOWNSEND AND CREW LLP;VIASAT, INC. (CLIENT #017018), TWO EMBARCADERO CENTER, 8TH FLOOR, SAN FRANCISCO, CA, 94111, US

(73) Assignee: ViaSat, Inc., Carlsbad, CA (US)

(21) Appl. No.: 12/685,691

(22) Filed: Jan. 12, 2010

Related U.S. Application Data
(63) Continuation-in-part of application No. 12/172,913, filed on Jul. 14, 2008.
(60) Provisional application No. 61/143,933, filed on Jan. 12, 2009.
(60) Provisional application No. 60/949,492, filed on Jul. 12, 2007.

(51) Int. Cl. G06F 15/16; G06F 3/048

(52) U.S. Cl. 715/760; 709/203

(57) ABSTRACT

The disclosure relates to systems, apparatus, and methods of reducing round trips associated with DNS lookups in ways that are substantially transparent to the user. Embodiments implement prefetching of DNS entries, sometimes piggybacking on the prefetching of associated web objects. In one embodiment, prefetching of an object continues according to other prefetching techniques, until the point where the HTML response may be parsed. When an embedded object request is identified, a DNS lookup is performed, and the resulting IP address is pushed to the client as part of a prefetch data package. In some embodiments, the client strips off the relevant portion of the prefetch data package to create a local DNS entry. The DNS entry may be used to locally handle DNS requests by the client, thereby potentially avoiding a round trip to a remote DNS.

### CROSS-REFERENCES

The present application is a continuation-in-part of co-pending, commonly assigned U.S. patent application Ser. No. 12/172,913, filed on Jul. 14, 2008, entitled “METHODS AND SYSTEMS FOR PERFORMING A PREFETCH ABORT OPERATION” (Attorney Docket No. 026841-000110US), which claims the benefit of U.S. Provisional Patent Application Ser. No. 60/949,492, filed Jul. 12, 2007, entitled “METHODS AND SYSTEMS FOR PERFORMING A PREFETCH ABORT OPERATION” (Attorney Docket No. 026841-000100US), both of which are hereby incorporated by reference herein in their entirety for all purposes. This application is also a non-provisional of and claims priority to U.S. Provisional Application No. 61/143,933, entitled WEB OPTIMIZATION OVER SATELLITE LINKS, filed on Jan. 12, 2009, which is incorporated by reference in its entirety for any and all purposes.

### FIELD

The present invention relates, in general, to network acceleration and, more particularly, to performing domain name prefetch operations.

### BACKGROUND

When requesting a webpage, a number of requests may be made to various uniform resource locators (URLs). For example, URL requests may be made to retrieve embedded content objects for use in rendering the webpage, including images, videos, sounds, etc. Each of the URLs may be associated with an internet protocol (IP) address, as designated by a domain name server (DNS). As such, before retrieving a web object, a request may have to be made to the DNS to find the IP address associated with the object's URL.

The DNS lookups may require that additional requests be made to the network, which may cause certain inefficiencies. For example, in a satellite communications system,

DNS lookups may involve additional round trips between the client user terminal and the server gateway sides of the communications system. Since each round trip over the satellite link takes time, these DNS lookups may cause undesirable system performance.

Some systems may configure user web browsers to use a hyper-text transfer protocol (HTTP) proxy at the server (e.g., gateway) side of the communications system for all DNS lookups. The client browser may forward all requests to the server-side proxy, so all the DNS lookups can be performed at the server side. In this way, DNS lookups may not use additional round trips. However, this implementation may require a particular type of browser configuration at the client side. This may be undesirable, as certain clients may not desire or know to configure their browsers in this way.

As such, it may be desirable to provide a different approach that is more transparent to the user, while still reducing round trips associated with DNS lookups.

### BRIEF SUMMARY

Among other things, methods, systems, devices, and software are provided for reducing round trips associated with DNS lookups in ways that are substantially transparent to the user. Embodiments implement prefetching of DNS entries, sometimes piggybacking on the prefetching of associated web objects. In one embodiment, prefetching of an object continues according to other prefetching techniques, until the point where the HTML response may be parsed. When an embedded object request is identified, a DNS lookup is performed to find the IP address for the request. The IP address is then pushed to the client as part of the prefetch data package (e.g., including the URL, the prefetched object, etc.).

In some embodiments, when the HTML response is received by the client, the client opens a prefetch socket. The client may use the prefetch socket to begin receiving the prefetch data, for example, including the DNS lookup results. As such, the client is aware of what data is being prefetched and can make further requests accordingly. For example, when a DNS request is made by the client, the request may be intercepted to determine whether the request can be handled using a local DNS entry. If so, the DNS response is handled locally and a round trip may be avoided. Notably, because of the awareness of what is being received via the prefetch socket, the client may wait to handle the request locally, even where the local DNS entry has not yet been fully received. As such, the round trip may be at least partially avoided even when the DNS request is made by the browser prior to completing receipt of the prefetched DNS entry.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 is a block diagram illustrating a system for performing prefetch abort operations, according to embodiments of the present invention;

FIG. 2 is a flow diagram illustrating a method for performing prefetch abort operations, according to one embodiment of the present invention;

FIG. 3 is a block diagram illustrating a system for accelerating network communications, according to one embodiment of the present invention;

FIG. 4 is a generalized schematic diagram illustrating a computer system, in accordance with various embodiments of the invention; and

FIG. 5 is a block diagram illustrating a networked system of computers, which can be used in accordance with various embodiments of the invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

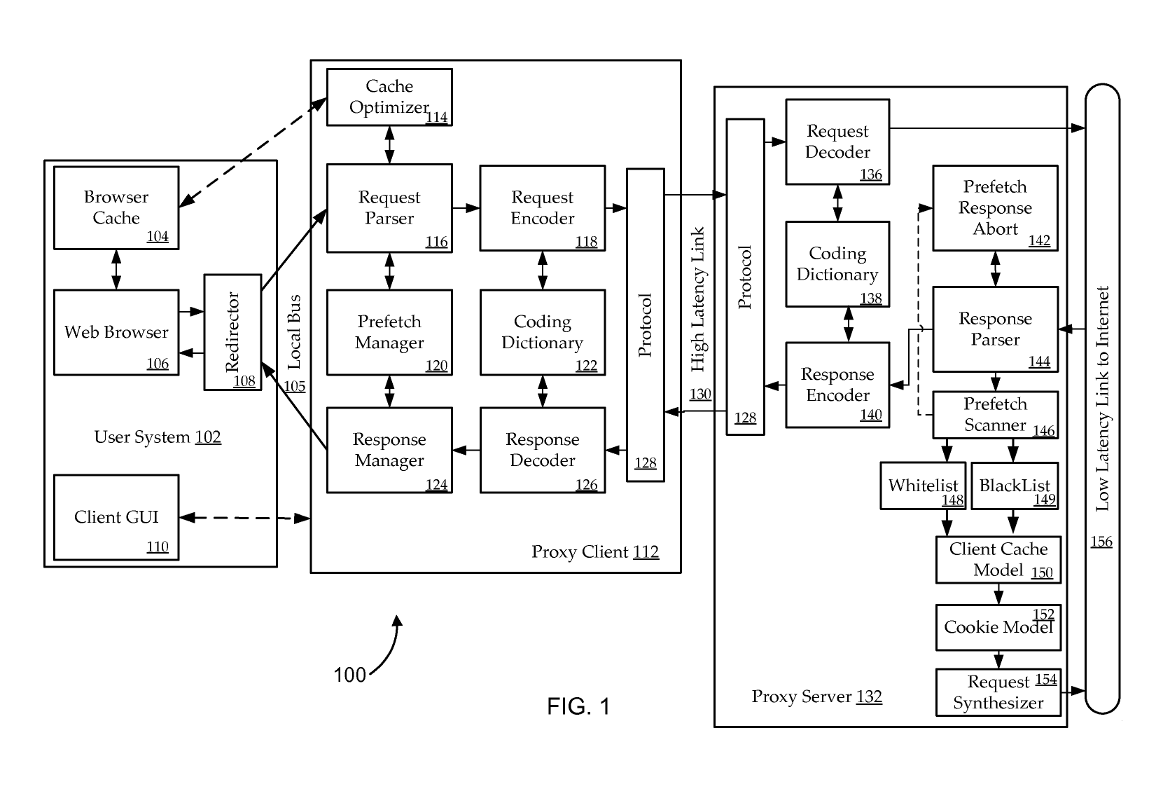

Turning first to FIG. 1, a system 100 for optimizing transfer of content from the Internet to a web browser is illustrated. In one embodiment, the system includes a user system 102, a proxy client 112, and a proxy server 132. The user system 102 may include a client graphical user interface (GUI) 110. Client GUI 110 may allow a user to configure performance aspects of the system 100. For example, the user may adjust the compression parameters and/or algorithms, content filters (e.g., blocks elicit websites), and enable or disable various features used by the system 100. In one embodiment, some of the features may include network diagnostics, error reporting, as well as controlling, for example, functionality of the proxy server 132. Such control may include adding and/or removing pages (i.e., URLs) to or from whitelist 148 and/or blacklist 149, etc.

In one embodiment, a user accesses a website through the web browser 106, for example, by providing the URL of the website to web browser 106. Rendering and/or using the website may typically include making a number of calls to other URLs. For example, the website may include embedded objects (e.g., advertisements, movies, sounds, images, etc.), links, etc. Each of these URLs may represent a location on the Intenet defined by an IP address. To retrieve the objects associated with the URLs, each URL may first have to be resolved to its corresponding IP address. This may typically be accomplished by issuing a lookup request to a DNS.

One traditional implementation may include issuing the DNS lookup requests from the client side of the system 100 (e.g., from the proxy client 112 or another component of the user system 102). When an object is requested, a client-side component may issue a request to a DNS to resolve the IP address of the object's URL, after which, the same or another client-side component may request the object using its resolved IP address. This may involve two requests to the Internet, which may result in two round trips. Particularly where each round trip is costly (e.g., where the round trip time is very long, as in a satellite communications system), client-side DNS lookup requests may be undesirable.

Another traditional implementation may include shifting the DNS lookup request role to the server side of the system 100 (e.g., to the proxy server 132). For example, user web browsers may be configured to use a server-side HTTP proxy for performing the DNS lookups. While this may avoid extra round trips incurred by performing the DNS lookups, the implementation may not be transparent to the user. For example, the configuration may involve affecting particular browser settings, running a client-side application, etc. Certain clients may not desire to configure their systems in this way for various reasons.

According to embodiments described herein, DNS lookups are implemented in such a way as to be relatively transparent to the user, while still avoiding extra round trips. For example, methods and systems may be substantially agnostic to the user's browser configuration, whether the user is running a particular application (e.g., a client-side optimization application), etc. Embodiments implement prefetching of the DNS entries along with or separate from the prefetching of associated web objects.

In some embodiments, prefetching of an object begins according to other prefetching techniques, like those described in U.S. patent application Ser. No. 12/172,913, filed on Jul. 14, 2008, entitled “METHODS AND SYSTEMS FOR PERFORMING A PREFETCH ABORT OPERATION,” which is hereby incorporated by reference herein in its entirety for all purposes. For example, after a user requests a website, web browser 106 may check browser cache 104 to determine whether the website associated with the selected URL is located within browser cache 104. If the website is located within browser cache 104, the amount of time the website has been in the cache is checked to determine if the cached website is “fresh” (i.e., new) enough to use. Consequently, if the website has been cached and the website is considered fresh, then web browser 106 renders the cached page. However, if the website has either not been cached or the cached webpage is not fresh, web browser 106 sends a request to the Internet for the website.

In one embodiment, redirector 108 intercepts the request sent from web browser 106. Redirector 108 instead sends the request through a local bus 105 to proxy client 112. In some embodiments, proxy client 112 may be implemented as a software application running on user system 102. In an alternative embodiment, proxy client 112 may be implemented on a separate computer system and is connected to user system 102 via a high speed/low latency link (e.g., a branch office LAN subnet, etc.). In one embodiment, proxy client 112 includes a request parser 116. Request parser 116 may check cache optimizer 114 to determine if a cached copy of the requested website may still be able to be used. Cache optimizer 114 is in communication with browser cache 104 in order to have access to cached websites. Cache optimizer 114 is able to access browser cache 104 without creating a redundant copy of the cached websites, thus requiring less storage space.

According to one embodiment, cache optimizer 114 implements more effective algorithms to determine whether a cached website is fresh. In one embodiment, cache optimizer 114 may implement the cache expiration algorithms from HTTP v1.1 (i.e., RFC 2616), which may not be natively supported in web browser 106. For example, browser cache 104 may inappropriately consider a cached website as too old to use; however, cache optimizer 114 may still be able to use the cached website. More efficient use of cached websites can improve browsing efficiency by reducing the number of Internet accesses.

In one embodiment, if the requested website is not able to be accessed from the cached websites, request parser 116 checks prefetch manager 120 to determine if the requested website has been prefetched. Prefetching a website is when content from the website is accessed, downloaded, and stored before a request to the website is made by web browser 106. Prefetching can potentially save round-trips of data access from user system 102 to the Internet.

In a further embodiment, if the requested website has not been prefetched, then request parser 116 forwards the request to a request encoder 118. Request encoder 118 encodes the request into a compressed version of the request using one of many possible data compression algorithms. For example, these algorithms may employ a coding dictionary 122 which stores strings so that data from previous web objects can be used to compress data from new pages. Accordingly, where the request for the website is 550 bytes in total, the encoded request may be as small as 50 bytes. This level of compression can save bandwidth on a connection, such as high latency link 130. In one embodiment, high latency link 130 may be a wireless link, a cellular link, a satellite link, a dial-up link, etc.

In one embodiment, after request encoder 118 generates an encoded version of the request, the encoded request is forwarded to a protocol 128. In one embodiment, protocol 128 is Intelligent Compression Technology's® (ICT) transport protocol (ITP). Nonetheless, other protocols may be used, such as the standard transmission control protocol (TCP). In one embodiment, ITP maintains a persistent connection with proxy server 132. The persistent connection between proxy client 112 and proxy server 132 enables system 100 to eliminate the inefficiencies and overhead costs associated with creating a new connection for each request.

In one embodiment, the encoded request is forwarded from protocol 128 to request decoder 136. Request decoder 136 uses a decoder which is appropriate for the encoding performed by request encoder 118. In one embodiment, this process utilizes a coding dictionary 138 in order to translate the encoded request back into a standard format which can be accessed by the destination website. Furthermore, if the HTTP request includes a cookie (or other special instructions), such as a “referred by” or type of encoding accepted, information about the cookie or instructions may be stored in a cookie model 152. Request decoder 136 then transmits the decoded request to the destination website over a low latency link 156. Low latency link 156 may be, for example, a cable modem connection, a digital subscriber line (DSL) connection, a T1 connection, a fiber optic connection, etc.

In response to the request, a response parser 144 receives a response from the requested website. In one embodiment, this response may include an attachment, such as an image and/or text file. Some types of attachments, such as HTML, XML, CSS, or Java Scripts, may include references to other “in-line” objects that may be needed to render a requested web page. In one embodiment, when response parser 144 detects an attachment type that may contain such references to “in-line” objects, response parser 144 may forward the objects to a prefetch scanner 146.

In one embodiment, prefetch scanner 146 scans the attached file and identifies URLs of in-line objects that may be candidates for prefetching. For example, candidates may be identified by HTML syntax, such as the token “img src=”. In addition, objects that may be needed for the web page may also be specified in java scripts that appear within the HTML or CSS page or within a separate java script file. Methods for identifying candidates within Java scripts may be found in a co-pending U.S. patent application Ser. No. 12/172,917, entitled “METHODS AND SYSTEMS FOR JAVA SCRIPT PARSING” (Attorney Docket No. 026841-000210US), filed Jul. 14, 2008, which is incorporated by reference for all purposes. In one embodiment, the identified candidates are added to a candidate list.

In one embodiment, for the candidate URLs, prefetch scanner 146 may notify prefetch response abort 142 of the context in which the object was identified, such as the type of object in which it was found and/or the syntax in which the URL occurred. This information may be used by prefetch response abort 142 to determine the probability that the URL will actually be requested by web browser 106.

According to a further embodiment, the candidate list is forwarded to whitelist 148 and blacklist 149. Whitelist 148 and blacklist 149 may be used to track which URLs should be allowed to be prefetched. Based on the host (i.e., the server that is supplying the URL), the file type (e.g., application service provider (ASP) files should not be prefetched), etc. Accordingly, whitelist 148 and blacklist 149 control prefetching behavior by indicating which URLs on the candidate list should or should not be prefetched. In many instances with certain webpages/file types, prefetching may not work. In addition to ASP files, webpages which include fields or cookies may have problems with prefetching.

In one embodiment, once the candidate list has been passed through whitelist 148 and blacklist 149, a modified candidate list is generated and then the list is forwarded to a client cache model 150. The client cache model 150 attempts to model which items from the list will be included in browser cache 104. As such, those items are removed from the modified candidate list. Subsequently, the updated modified candidate list is forwarded to a request synthesizer 154 which creates an HTTP request in order to prefetch each item in the updated modified candidate list. The HTTP request header may include cookies and/or other instructions appropriate to the website and/or to web browser 106's preferences using information obtained from cookie model 152. The prefetch HTTP requests may then be transmitted through low latency link 156 to the corresponding website.

In one embodiment, response parser 144 receives a prefetch response from the website and accesses a prefetch response abort 142. Prefetch response abort 142 is configured to determine whether the prefetched item is worth sending to user system 102. Prefetch response abort 142 bases its decision whether to abort a prefetch on a variety of factors, which are discussed below in more detail.

If the prefetch is not aborted, response parser 144 forwards the response to response encoder 140. Response encoder 140 accesses coding dictionary 138 in order to encode the prefetched response. Response encoder 140 then forwards the encoded response through protocol 128 over high latency link 130 and then to response decoder 126. Response decoder 126 decodes the response and forwards the response to response manager 124. In one embodiment, if the response is a prefetched response, then response manager 124 creates a prefetch socket to receive the prefetched item as it is downloaded.

It will be appreciated that, in making HTTP requests, URLs associated with the requested (e.g., prefetch) objects may have to be resolved to determine corresponding IP addresses. For example, a DNS lookup may be performed to resolve the URLs for each prefetch object. Rather than discarding the results of the DNS lookup after the HTTP request is made, the DNS lookup result may be added to the prefetch data pushed to the client. As such, in some embodiments, when the response encoder 140 forwards the encoded response through protocol 128 over high latency link 130 to response decoder 126, the response includes the DNS lookup results (e.g., the IP address associated with the URL). Further, when the response is a prefetch response, the DNS lookup results may be received at the client as they are downloaded via the prefetch socket created by response manager 124.

In some embodiments, when response decoder 126 decodes the response, it is stripped of certain data relating to the DNS lookup and creates a DNS prefetch entry. For example, the DNS prefetch entry may include the URL and its associated IP address. Certain embodiments may store the DNS entry locally for future use. Other embodiments temporarily store the DNS entry (e.g., in a scratch pad) in anticipation of an impending request. For example, when the DNS information is received, it may be assumed that a request for that DNS will be made shortly thereafter, if at all.

Response manager 124 transmits the response over local bus 105 to redirector 108. Redirector 108 then forwards the response to web browser 106 which renders the content of the response. After web browser 106 receives the response, rendering the content may involve requesting one or more content objects from the web (e.g., videos, images, sounds, etc.). Each content object may be located at a URL, and each URL may have to be resolved to a valid host IP address prior to requesting the content object. As discussed above, resolving the URLs may typically involve querying a DNS to find the associated IP address.

In some embodiments, the DNS lookup request may be intercepted by the redirector 108. Redirector 108 may instead send the request through a local bus 105 to proxy client 112. As discussed above, some DNS entries may have been prefetched and stored locally, or may be in the process of being prefetched. As such, the request parser 116 in the proxy client may check prefetch manager 120 to determine if the requested DNS lookup has been, or is in the process of being, prefetched.

If the requested DNS lookup has been, or is being, prefetched, the DNS request may be handled locally. For example, if it is determined that the DNS request can be handled locally, response manager 124 may transmit the DNS response over local bus 105 to redirector 108. The object request can then proceed without first making a round trip (e.g., across high latency link 130) to the DNS. If it is determined that the DNS request cannot be handled locally, it may be passed along for normal processing (e.g., over high latency link 130 to the DNS).

It is worth noting that the HTML response may be received at the client, and web browser 106 may begin requesting DNS lookups, before the respective DNS prefetch entries have been created (e.g., before they have finished downloading). However, as discussed above, the client may be made aware of what will be prefetched as part of the HTML response. For example, embodiments of the client receive the DNS lookup results via a prefetch socket (e.g., acting as a DNS proxy) configured by the client to receive particular prefetch objects. As such, even when the DNS prefetch entry has not been completed, the client may be aware that the DNS information is in the process of being prefetched. Consequently, the client may decide to wait for the local DNS entry to be completely prefetched to allow local handling of the DNS request.

It is further worth noting that, as discussed above, certain objects may not be prefetched, even where the URL is embedded or otherwise part of an HTTP request. For example, it may be determined that it would be inefficient to prefetch the object because of its size, because there is a very low probability that the object will ultimately be requested by the user, because the URL represents a link (e.g., HREF) or other web item that is not a prefetch candidate, because the object is on the blacklist 149, etc. Certain embodiments still prefetch the DNS and create a local DNS entry, even when it is determined not to prefetch the associated object. In fact, some embodiments prefetch all DNS information, whenever practical.

For example, piggybacking the DNS lookup result (the IP address) onto the URL when an object is prefetched may only add a few bytes (e.g., 4 or 6 bytes to describe typical IP addresses) to the prefetch data package. Even if the DNS lookup is pushed without an associated object (e.g., along with other data), the total additional prefetch data may still be minimal. As such, the cost of prefetching the DNS entry may be very small compared to the cost of the round trip, particularly where round trip times are large (e.g., in a satellite communications system).

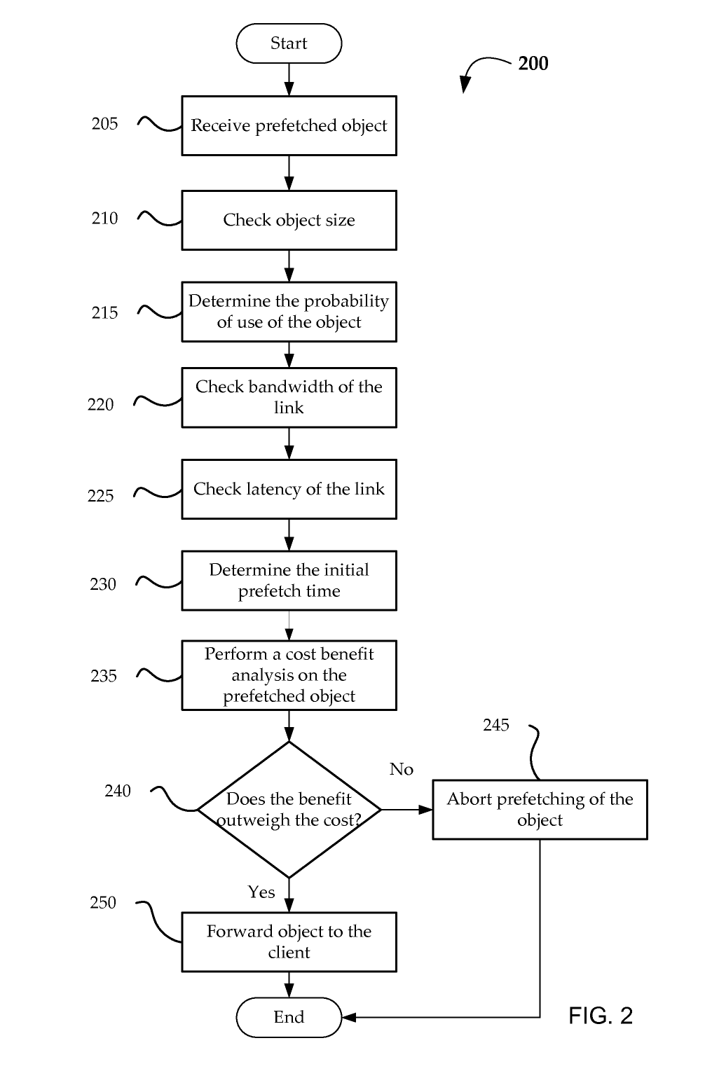

Turning now to FIG. 2, which illustrates method 200, one embodiment of the operations performed by prefetch response abort 142 (FIG. 1) is shown. As discussed above, prefetch response abort 142 (FIG. 1) receives a prefetched object from the Internet through low latency link 156 (FIG. 1) (process block 205). Even though the object has initially been prefetched, it does not necessarily mean that it is efficient to forward the object to the client (e.g., proxy client 112 (FIG. 1)). Due to bandwidth and other constraints of the link, objects sent over high latency link 130 (FIG. 1) between proxy server 132 (FIG. 1) and proxy client 112 (FIG. 1) should be carefully selected. Accordingly, a variety of factors should be considered before forwarding a prefetched object to the client.

At process block 210, the size of the received object is checked. In one embodiment, the size of the object may be significant in determining whether to forward the object to the client. For example, one benefit of forwarding the prefetched object to the client may be the elimination of a round trip. In other words, if a prefetched item is eventually used by user system 102 (FIG. 1), the request out to the Internet and the response back from the requested website (i.e., one round trip) can be eliminated. Hence, in some instances, the smaller the prefetched object is, the more beneficial the prefetch is for optimization purposes.

Furthermore, one potential negative effect of forwarding a prefetched object is that the prefetched object unnecessarily uses the link's bandwidth. As such, if a prefetched object is forwarded to the client but never used by the client, the bandwidth used to forward the object may be wasted. Accordingly, larger prefetched objects may decrease optimization because the gained round trip may not outweigh the bandwidth consumption. In one embodiment, a point system may be assigned to the prefetched object where, for example, a 10 kilobyte object is given a higher point value than a 10 megabyte object. Consequently, if the point value associated with the object reaches or exceeds a threshold, then the object is forwarded to the client.

Another factor in determining whether an object should be forwarded to the client is the probability of use of the object (process block 215). As a user browses the Internet, not all URLs that are prefetched will actually be requested by web browser 106. The user may, for example, “click-off” a web page before objects within the page are requested. Whether some objects may be requested may depend on browser settings and/or on external events, such as mouse position. Furthermore, objects referenced on a CSS (e.g., style sheet for the entire website) may not be used on each individual web page. In addition, if URLs are identified within Java scripts, the scripts themselves, based on a variety of factors, may determine whether to request an object.

In one embodiment, the probability that an object will actually be requested by web browser 106 may be estimated as a function of the context in which the reference was identified. For example, this context may depend on the type of the object (e.g., HTML, CSS, JS, etc.), the surrounding syntax (e.g., “img src=”, java script, etc.), and the level of recursion (e.g., was the reference on the main HTML or on an object that was itself prefetched). In one embodiment, if the object was referenced in a Java script, the probability of use may depend on information collected while parsing the script. The probability that an object in a specific context will be requested can be estimated in several ways. For example, a general model can be built sampling many different clients in many sessions going to many websites. Subsequently, a more specific model can be developed for a specific website and/or for a particular user. In one embodiment, this may be accomplished by recording the frequency of page use in a specific context for a specific web page by a specific user.

Collectively, based on the above-mentioned probability factors, the object may be assigned a point value associated with its probability of use. In an alternative embodiment, the probability of use may be assigned a percentage value.

At process block 220, the bandwidth of high latency link 130 (FIG. 1) may be determined (i.e., the speed of the link between proxy server 132 (FIG. 1) and proxy client 112 (FIG. 1)). The bandwidth of this link can be a factor in determining whether to forward the prefetched object. For example, with a higher link bandwidth, more objects and larger objects could be forwarded to the client. However, in contrast, if the bandwidth of the link is lower, then prefetch response abort 142 (FIG. 1) may be more selective when deciding whether to forward the prefetched object. In one embodiment, the bandwidth of the link is assigned a point value which may be factored into the determination of whether to forward the object.

At process block 225, the latency of the link between proxy server 132 (FIG. 1) and proxy client 112 (FIG. 1) is determined. In one embodiment, the latency of the link is based on the current round trip time (RTT) of the link. Accordingly, if the RTT is high, then it may be more beneficial to forward the prefetched object to the client because of the round trip savings gained by forwarding the object. However, if the RTT is low, then the saved round trip may be of less value for optimization purposes. In one embodiment, the latency of the link is assigned a point value which may be factored into the determination of whether to forward the object.

In process block 230, the initial prefetch time is determined (i.e., how long the object took to be retrieved from the Internet). If the object took a long time to retrieve from the Internet, then it may be optimal to forward the object to the client in order to avoid re-downloading the object in the future. Furthermore, if the object was downloaded quickly, then less optimization may be gained from forwarding the object to the client. Hence, in one embodiment, the download time of the object may be assigned a point value which may be factored into determining whether to forward the object to the client. In an alternative embodiment, the aborted objects may be stored on proxy server 132 (FIG. 1) in case they are subsequently requested. Accordingly, if these objects are stored and then requested, the download will not need to be repeated. If this approach is implemented, then process block 230 may not be used.

At process block 235, a cost/benefit analysis may be preformed to determine whether to forward the prefetched object. In one embodiment, the above-mentioned point values may be calculated to determine if the object meets a predetermined threshold. In an alternative embodiment, the cost of forwarding the object may be determined using the following equation:

Cost=ObjectSize*(1.0−ProbabilityofUse)/Bandwidth

Furthermore, in one embodiment, the benefit of forwarding the prefetched object may be determined using the following equation:

Benefit=ProbabilityofUse*(RTT+PrefetchTime)

Accordingly, by using these or other equations, at decision block 240, if the cost value is greater than the benefit value, then the prefetched object is aborted and the object is not forwarded to the client (process block 245). Conversely, if the benefit is greater than the cost, then the prefetched object is forwarded to the client (process block 250). In an alternative embodiment, objects that have been aborted may be cached at, for example, proxy server 132 (FIG. 1), in the event that the client subsequently requests the object. Hence, the above referenced equation may be reduced to:

Benefit=ProbabilityofUse*RTT

The equation is reduced in this manner because, since the object has already been downloaded, it would not need to be re-downloaded from the originating server.

A number of variations and modifications of the disclosed embodiments can also be used. For example, the factors used to determine whether to forward a prefetched object may be used outside the website and/or Internet context. For example, the prefetching technique may be used to determine which terminals to download an object from in a peer-to-peer network environment. In addition, the prefetching technique may be used on various network types, for example, a satellite network, a mobile device network, etc.

It is worth noting that the same or different cost-benefit equations may be applied to prefetching of DNS entries, as described with reference to FIG. 1. For example, referring to the equations described above, object size factors primarily (e.g., or only) into the cost, and RTT factors primarily (e.g., or only) into the benefit. When the object size is very small (e.g., the DNS lookup result involves only a small number of bytes), the prefetch cost may be very small. When the RTT is relatively constant (e.g., the time to traverse the satellite link may not change much), the prefetch cost may be relatively constant. As such, the benefits may clearly outweigh the costs predicted for prefetching the DNS entries. Moreover, the costs become even further outweighed as the RTT increases.

It is further worth noting, as discussed above, that the size of the DNS prefetch data may be very small, regardless of whether the DNS data is prefetched on its own (e.g., with the associated URL) or as a piggyback operation along with prefetching an object. Consequently, it may be efficient to prefetch DNS data, even where no associated objects are prefetched. For example, even where the method 200 of FIG. 2 results in a determination to abort the prefetch operation, it may still be efficient to push associated DNS data to the client.

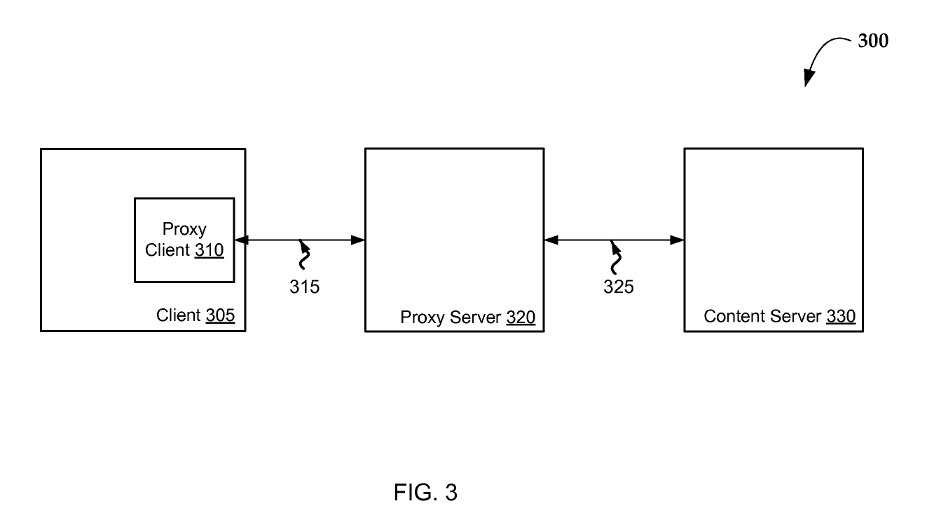

Referring now to FIG. 3, a system 300 for providing network acceleration is illustrated. In one embodiment, user system 102 in FIG. 1 may be client 305 and proxy client 112 in FIG. 1 may be proxy client 310. Client 305 may generate a request for content from content server 330. In one embodiment, content server 330 may be a web server, a file server, a mail server, etc., and the content request may be for a file, a webpage, an email message, etc.

Proxy client 310 may be configured to intercept the content request from client 305 and transmit the request over high latency link 315 to proxy server 320 on behalf of client 305. In one embodiment, high latency link 315 may be a satellite link, a cellular link, a wireless link, etc. In one embodiment, the content request may include references to prefetchable content. Accordingly, proxy server 320, while prefetching objects for network acceleration, may utilize the systems and methods described in FIGS. 1 and 2.

In a further embodiment, communications between proxy server 320 and content server 330 over low latency link 325 are sufficiently fast that acceleration is not needed or would not provide sufficient benefit for the cost needed to accelerate. Hence, upon receipt of communications from content server 330, proxy server 320 accelerates the communications between proxy server 320 and proxy client 310 in order to accelerate communications over high latency link 315. Accordingly, the network traffic over high latency link 315 is accelerated while network traffic over low latency link 325 remains relatively unchanged.

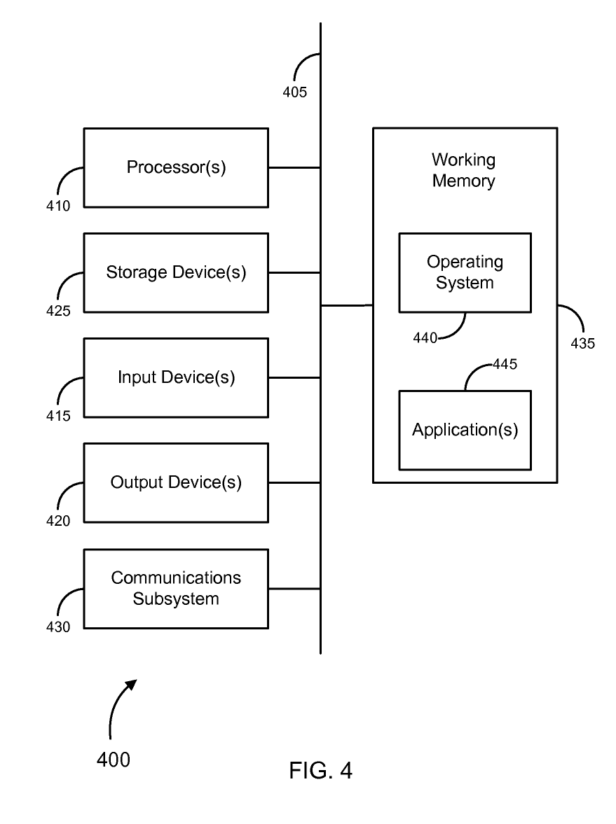

FIG. 4 provides a schematic illustration of one embodiment of a computer system 400 that can perform the methods of the invention, as described herein, and/or can function, for example, as any part of client 305, proxy server 320, or content server 330 in FIG. 3. It should be noted that FIG. 4 is meant only to provide a generalized illustration of various components, any or all of which may be utilized, as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements can include one or more processors 410, including, without limitation, one or more general-purpose processors and/or one or more special-purpose processors (such as digital signal processing chips, graphics acceleration chips, and/or the like); one or more input devices 415, which can include, without limitation, a mouse, a keyboard, and/or the like; and one or more output devices 420, which can include, without limitation, a display device, a printer, and/or the like.

The computer system 400 may further include (and/or be in communication with) one or more storage devices 425, which can comprise, without limitation, local and/or network accessible storage and/or can include, without limitation, a disk drive, a drive array, an optical storage device, a solid-state storage device such as a random access memory (“RAM”) and/or a read-only memory (“ROM”), which can be programmable, flash-updateable, and/or the like. The computer system 400 might also include a communications subsystem 430, which can include, without limitation, a modem, a network card (wireless or wired), an infra-red communication device, a wireless communication device, and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440 and/or other code, such as one or more application programs 445, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 400) to perform methods of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another machine-readable medium, such as one or more of the storage device(s) 425. Merely by way of example, execution of the sequences of instructions contained in the working memory 435 might cause the processor(s) 410 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 400, various machine-readable media might be involved in providing instructions/code to processor(s) 410 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 425. Volatile media includes, without limitation, dynamic memory, such as the working memory 435. Transmission media includes coaxial cables, copper wire, and fiber optics, including the wires that comprise the bus 405, as well as the various components of the communications subsystem 430 (and/or the media by which the communications subsystem 430 provides communication with other devices). Hence, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals, and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc., carried by the signals) to the working memory 435, from which the processor(s) 410 retrieves and executes the instructions. The instructions received by the working memory 435 may optionally be stored on a storage device 425 either before or after execution by the processor(s) 410.

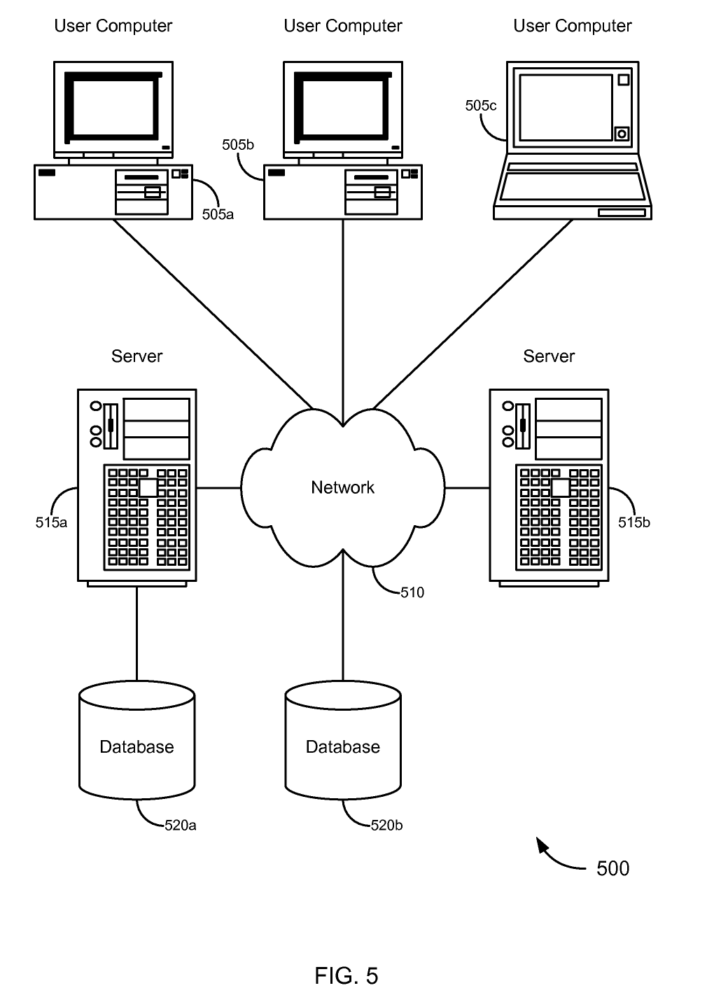

In one embodiment, proxy server 320 and/or client 305 (as shown in FIG. 3) may be implemented as computer system 400 in FIG. 4. Merely by way of example, FIG. 5 illustrates a schematic diagram of a system 500 that can be used in accordance with one set of embodiments. The system 500 can include one or more user computers 505. The user computers 505 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 505 can also have any of a variety of applications, including one or more applications configured to perform methods of the invention, as well as one or more office applications, database client and/or server applications, and web browser applications. Alternatively, the user computers 505 can be any other electronic device, such as a thin-client computer, Internet-enabled mobile telephone, and/or personal digital assistant (PDA), capable of communicating via a network (e.g., the network 510 described below) and/or displaying and navigating web pages or other types of electronic documents. Although the exemplary system 500 is shown with three user computers 505, any number of user computers can be supported.

Certain embodiments of the invention operate in a networked environment, which can include a network 510. The network 510 can be any type of network familiar to those skilled in the art that can support data communications using any of a variety of commercially-available protocols, including, without limitation, TCP/IP, SNA, IPX, AppleTalk, and the like. Merely by way of example, the network 510 can be a local area network (“LAN”), including, without limitation, an Ethernet network, a Token-Ring network and/or the like; a wide-area network (WAN); a virtual network, including, without limitation, a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including, without limitation, any of those discussed above, as well as any commercially (or freely) available server operating systems. Each of the servers 515 may also be running one or more applications, which can be configured to provide services to one or more user computers 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 505 to perform methods of the invention.

The server computers 515, in some embodiments, might include one or more application servers, which can include one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including, without limitation, web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™, and the like, which can process requests from clients (including, depending on the configurator, database clients, API clients, web browsers, etc.) running on a user computer 505 and/or another server 515. In some embodiments, an application server can create web pages dynamically for displaying the information in accordance with embodiments of the invention, such as information displayed on web browser 106 in FIG. 1. Data provided by an application server may be formatted as web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement methods of the invention incorporated by an application running on a user computer 505 and/or another server 515. Alternatively, as those skilled in the art will appreciate, a file server can include all necessary files, allowing such an application to be invoked remotely by a user computer 505 and/or server 515. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505 or servers 515, so long as the database 520b can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505 or servers 515 can be stored locally on the respective computer and/or remotely, as appropriate.) In one set of embodiments, the database 520 can be a relational database, such as an Oracle™ database, that is adapted to store, update, and retrieve data in response to SQL-formatted commands. The database might be controlled and/or maintained by a database server, as described above, for example.

A number of variations and modifications of the disclosed embodiments can also be used. For example, prefetching, including DNS prefetching, may be used outside the website and/or Internet context. For example, prefetching techniques may be used to determine which terminals to download an object from in a peer-to-peer network environment. In addition, the prefetching technique may be used on various network types, for example, a satellite network, a mobile device network, etc.

While the invention has been described with respect to exemplary embodiments, one skilled in the art will recognize that numerous modifications are possible. For example, the methods and processes described herein may be implemented using hardware components, software components, and/or any combination thereof Further, while various methods and processes described herein may be described with respect to particular structural and/or functional components for ease of description, methods of the invention are not limited to any particular structural and/or functional architecture but instead can be implemented on any suitable hardware, firmware, and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added, and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method for prefetching domain name server (DNS) entries in a communications system, the method comprising:
receiving response data in response to a request for a content set, the content set comprising a plurality of content objects, each content object associated with a network location that is remote over the communications system;
determining when the response data comprises a DNS prefetch response indicating prefetching of DNS information corresponding to the network location associated with a prefetch object, the prefetch object being one of the plurality of content objects;
when the response data comprises the DNS prefetch response, establishing a prefetch channel configured to receive the DNS information over the communications system as indicated by the DNS prefetch response;
intercepting a DNS lookup request associated with the prefetch object; and
locally satisfying the DNS lookup request using the DNS information.

2. The method of claim 1, further comprising:
after intercepting the DNS lookup request, determining that the DNS lookup request can be satisfied with the DNS information still being received over the prefetch channel; and
waiting for the DNS information to be fully received prior to locally satisfying the DNS lookup request using the DNS information.

3. The method of claim 1, wherein at least the receiving step and the intercepting step are implemented using a proxy client.

4. The method of claim 1, further comprising:
storing the DNS information received over the prefetch channel in a local data store.

5. The method of claim 1, wherein the DNS lookup request is issued to a remote DNS.

6. The method of claim 1, wherein the prefetch channel is a network socket.

7. The method of claim 1, wherein the request for the content set is received in response to selection of a link using a web browser.

8. The method of claim 1, wherein the DNS information comprises an Internet protocol (IP) address corresponding to the network location associated with the prefetch object.

9. The method of claim 1, wherein the request for the content set is received in response to selection of a link using a web browser.

10. The method of claim 1, wherein the response data is an HTML response or an HTTP response.

11. The method of claim 1, wherein the content set is a webpage.

12. A system for handling prefetching of domain name server (DNS) entries at a client side of a communications system, the system comprising:
a response processing module, communicatively coupled with and local to a client machine, and configured to:
receive response data in response to a request for a content set from the client machine, the content set comprising a plurality of content objects, each content object associated with a network location that is remote over the communications system; and
determine when the response data comprises a DNS prefetch response indicating prefetching of DNS information corresponding to the network location associated with a prefetch object, the prefetch object being one of the plurality of content objects; and
a DNS prefetch module, communicatively coupled with the response processing module and the client machine, and configured to:
when the response data comprises the DNS prefetch response, establish a prefetch channel configured to receive the DNS information from a server side of the communications network as indicated by the DNS prefetch response;
intercept a DNS lookup request associated with the prefetch object from the client machine; and
return a DNS lookup response to the client machine in satisfaction of the DNS lookup request using the DNS information.

13. The system of claim 12, wherein the DNS prefetch module is further configured to:
after intercepting the DNS lookup request, determine that the DNS lookup request can be satisfied with the DNS information still being received over the prefetch channel; and
wait for the DNS information to be fully received prior to returning the DNS lookup response.

14. The system of claim 12, further comprising:
a data store, communicatively coupled with the response processing module, and configured to store the DNS information received over the prefetch channel.

15. The system of claim 12, wherein the DNS lookup request is issued by the client machine to a remote DNS.

16. The system of claim 12, wherein the DNS information comprises an Internet protocol (IP) address corresponding to the network location associated with the prefetch object.

17. A machine-readable medium for handling prefetching of domain name server (DNS) entries in a communications system, the machine-readable medium having instructions stored thereon which, when executed by a machine, cause the machine to perform steps comprising:
receiving response data in response to a request for a content set, the content set comprising a plurality of content objects, each content object associated with a network location that is remote over the communications system;
determining when the response data comprises a DNS prefetch response indicating prefetching of DNS information corresponding to the network location associated with a prefetch object, the prefetch object being one of the plurality of content objects;
when the response data comprises the DNS prefetch response, establishing a prefetch channel configured to receive the DNS information over the communications network as indicated by the DNS prefetch response;
intercepting a DNS lookup request associated with the prefetch object; and
locally satisfying the DNS lookup request using the DNS information.

18. The machine-readable medium of claim 17, the instructions stored thereon, when executed by the machine, causing the machine to perform steps further comprising:
after intercepting the DNS lookup request, determining that the DNS lookup request can be satisfied with the DNS information still being received over the prefetch channel; and
waiting for the DNS information to be fully received prior to locally satisfying the DNS lookup request using the DNS information.

19. The machine-readable medium of claim 17, wherein the machine is configured as a proxy client.

20. The machine-readable medium of claim 17, the instructions stored thereon, when executed by the machine, causing the machine to perform steps further comprising:
storing the DNS information received over the prefetch channel in a data store communicatively coupled with the machine.
